(19) United States
(12) Patent Application Publication
(10) Pub. No.: US 2024/0070677 A1
(43) Pub. Date: Feb. 29, 2024

(54) AGGREGATED TRANSACTION ACCOUNTS

(71) Applicant: Joseph Wayne Stafford, Atlanta, GA (US)

(72) Inventor: Joseph Wayne Stafford, Atlanta, GA (US)

(21) Appl. No.: 17/986,253

(22) Filed: Nov. 14, 2022

Related U.S. Application Data
(63) Continuation of application No. 17/403,328, filed on Aug. 16, 2021, now abandoned.
Application No. 17/403,328 is a continuation of application No. 17/068,763, filed on Oct. 12, 2020, now abandoned.

(51) Int. Cl. G06Q 20/40; G06Q 40/02

(52) U.S. Cl. CPC G06Q 20/405; G06Q 20/4037; G06Q 40/02; G06Q 20/4018; G06Q 30/0185

(57) ABSTRACT

Disclosed are various embodiments for using aggregated transaction accounts to make purchases. A transaction authorization request for a transaction is received from a merchant device, the transaction authorization request comprising an aggregated transaction account identifier, a transaction amount, and a merchant identifier. Multiple linked transaction accounts associated with an aggregated transaction account identified by the aggregated transaction account identifier are then identified or selected. At least a portion of the transaction amount is debited from each of the multiple linked transaction accounts. Then, an authorization response is sent to the merchant device, the authorization response indicating that the transaction is authorized for the transaction amount.

### CROSS-REFERENCE TO RELATED APPLICATIONS

This application is a continuation of, and claims priority to, co-pending U.S. patent application entitled “AGGREGATED TRANSACTION ACCOUNTS,” filed on Oct. 12, 2020, and assigned application Ser. No. 17/068,763, which is incorporated herein by reference in its entirety.

### BACKGROUND

Individuals often have multiple transaction accounts. For example, one person could have multiple credit cards as well as multiple debit cards. Each credit card could have both a different credit limit and/or a different outstanding balance. Likewise, each debit card could have a different available balance which could be used for purchases. However, these transaction accounts cannot be consolidated for use for a large purpose. For example, if an individual wished to make a $1,000 purchase and had two credit cards with $600 in available credit each (e.g., $1,200 total), the individual could not combine the available credit of the two credit cards to make the $1,000 purchase.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2A is a flowchart diagram illustrating one example of functionality implemented as portions of an application executed in a computing environment in the network environment of FIG. 1 according to various embodiments of the present disclosure.

FIG. 2B is a flowchart diagram illustrating one example of functionality implemented as portions of an application executed in a computing environment in the network environment of FIG. 1 according to various embodiments of the present disclosure.

FIG. 3 is a sequence diagram illustrating one example of functionality implemented as in the network environment of FIG. 1 according to various embodiments of the present disclosure.

FIGS. 4A-4H are pictorial diagrams of an example user interface rendered by a client in the network environment of FIG. 1 according to various embodiments of the present disclosure.

FIG. 5 is a sequence diagram illustrating one example of functionality implemented in the network environment of FIG. 1 according to various embodiments of the present disclosure.

### DETAILED DESCRIPTION

Disclosed are various approaches for pooling or aggregating available credit, available balances, etc. of transaction accounts and allowing an individual to make purchases backed by the pooled or aggregated available credit and available balances using a single transaction account. Users may be able to see how much available credit or available balance is free for a subsequent purchase, select which account or accounts to use for a subsequent purchase, and perform other actions. Because a single transaction account can be used to make purchases, a charge can be made using traditional payment systems (e.g., ecommerce websites, in-store payment terminals, etc.) regardless of whether those payment systems support split transactions.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

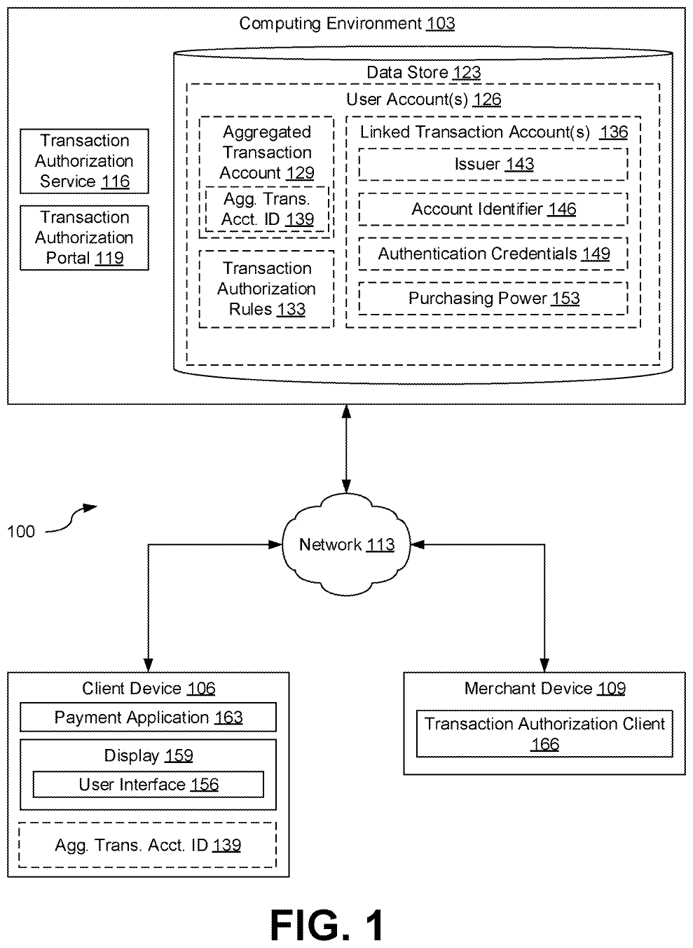

As illustrated in FIG. 1, shown is a network environment 100 according to various embodiments. The network environment 100 can include a computing environment 103, a client device 106, and a merchant device 109, which can be in data communication with each other via a network 113.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include a transaction authorization service 116, a transaction authorization portal 110, and other applications, services, processes, systems, engines, or functionality not discussed in detail herein.

Also, various data is stored in a data store 123 that is accessible to the computing environment 103. The data store 123 can be representative of a plurality of data stores 123, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 123 is associated with the operation of the various applications or functional entities described below. This data can include one or more user accounts 126, and potentially other data.

Each user account 126 can represent information associated with a user of the transaction authorization service 116 and/or the transaction authorization portal 119. Accordingly, various information about the user may be stored in the user account 126. This can include an aggregated transaction account 129 created on behalf of the user and assigned to the user, one or more transaction authorization rules 133 for the aggregated transaction account 129, and one or more linked transaction accounts 136 of the user.

The aggregated transaction account 129 is a transaction account that can be used wherever payment cards, such as debit, credit, or charge cards, are accepted. The aggregated transaction account 129 can include an aggregated transaction account identifier 139, which may be formatted in accordance with the ISO/IEC 7812 standard for Identification Cards. Accordingly, the aggregated transaction account identifier 139 can include both an issuer identification number (IIN) and a primary account number (PAN), as well as a validation digit or check digit (e.g., a digit calculated using the Luhn algorithm). The aggregated transaction account 129 can also include a card security code (CSC), card code verification (CCV), card verification data (CVD), card verification value (CVV), card identification code (CIC), or similar security feature. Accordingly, the aggregated transaction account 129 could be used as payment instrument with any system that accepts payment cards generally, such as payment or point of sale (PoS) terminals, ecommerce applications or websites (e.g., electronic commerce shopping carts), or peer-to-peer stored value payment applications or networks (e.g., PAYPAL®, VENMO®, etc.).

The transaction authorization rules 133 are rules that specify how a purchase made using the aggregated transaction account 129 should be processed. In some implementations, one or more of the transaction authorization rules 133 can be used created or user defined. However, the entity that offers the aggregated transaction account 129 to users as a service can also create and assign one or more transaction authorization rules 133 to a user account 126. Transaction authorization rules 133 can also be temporary, time-limited, or conditional. However, other transaction authorization rules 133 may be permanent or otherwise in effect until deleted or altered. In some implementations, a transaction authorization rule 133 can also include a priority indicator, which can be used when to select a preferred transaction authorization rule 133 when multiple transaction authorization rules 133 apply to a particular transaction.

Several examples of transaction authorization rules 133 are set forth herein. However, these examples are solely for illustrative purposes, as any transaction authorization rule 133 could be created as desired for a particular user or use case. For example, one transaction authorization rule 133 could specify that a transaction amount (e.g., the amount for goods or services associated with a particular transaction initiated or completed using the aggregated transaction account 129), should be spread evenly across all linked transaction accounts 136. Similarly, a transaction authorization rule 133 could specify that a transaction amount for a transaction should cascade between linked transaction accounts 136, using the entire available credit or available balance of a first linked transaction account 136 before using any portion of the available credit or balance of a second (or subsequent) linked transaction account 136. As another example, a transaction authorization rule 133 could specify that a transaction amount for next purchase should be applied to one or more specified linked transaction accounts 136. Another transaction authorization rule 133 could specify that transactions with a specific merchant using the aggregated transaction account 129 should be applied to a specified linked transaction account 136 (e.g., that payments to a particular airline or hotel using the aggregated transaction account 129 should be applied to an airline's linked transaction account 136 or a hotel's linked transaction account 136, respectively).

The linked transaction accounts 136 are those payment accounts or instruments (e.g., debit cards, credit cards, stored-value payment cards, etc.) that a user has linked to his or her aggregated transaction account 129 to allow for a payment to be made using the aggregated transaction account 129. For example, a user could add several debit, credit, or gift cards to his or her user account 126. When a transaction is performed using the aggregated transaction account 129, the payment for the transaction could be made using one or more linked transaction accounts 136, as described in further detail later.

Each linked transaction account 136 can include information that allows for a transaction using the aggregated transaction account 129 to be completed using a linked transaction account 136 for partial or complete payment. This information can include the issuer 143 of the linked transaction account 136, the account identifier 146 of the linked transaction account 136, authentication credentials 149 for accessing information associated with the linked transaction account 136 on behalf of the user, the purchasing power 153 of the linked transaction account 136, and potentially other information. Other information can also be stored in association with the linked transaction account 136 according to various embodiments of the present disclosure.

The issuer 143 can represent the identity of the financial institution that provides the linked transaction account 136. This can include the name of the financial institution (e.g., the name of the bank) and information regarding how to contact or reach out to the financial institution to process a transaction or retrieve information. This can include such information as an American Bankers Association Routing Transit Number (ABA-RTN, also known informally as a “routing number”), a uniform resource locator (URL) for the website of the financial institution, or a URL for a web service that provides an application programming interface (API) that allows other applications to programmatically interact with the information technology (IT) systems of the financial institution.

The account identifier 146 can represent any identifier for the linked transaction account 136 that uniquely identifies the linked transaction account 136 with respect to another linked transaction account 136. For example, the account identifier 146 could be a payment card number (as previously discussed), a bank account number, etc.

The authentication credentials 149 include those credentials that the user could use to authenticate with the issuer 143 of the linked transaction account 136. These could include, for example, a user name and password that could be used to access a website of or authenticate with a web service provided by the issuer 143. These could also include authentication tokens or unique authentication codes that allow for access to the systems of the issuer 143 without having to store a username and password. Other types of authenticating information can also be stored according to various embodiments of the present disclosure.

The purchasing power 153 of the linked transaction account 136 can represent an amount of money that can be charged to the linked transaction account 136. In the case of a credit card, this could represent an available amount of credit to the user. In the case of a debit card or a stored-value payment instrument, this could represent a remaining balance of funds (e.g., in a demand deposit account associated with the debit card or stored in the stored-value payment instrument). The purchasing power 153 can be determined by querying the systems of the issuer 136 using the authentication credentials 149 and receiving an available credit or balance in return.

The transaction authorization service 116 can be executed to initiate, complete, and/or authorize payments to a third party using an aggregated transaction account 129. For example, when a user provides his or her aggregated transaction account identifier 139 to a merchant, the merchant may request that the transaction authorization service 116 authorize payment. The transaction authorization service 116 can then charge the transaction amount supplied by the merchant to one or more linked transaction accounts 136, as specified by an applicable transaction authorization rule 133. Once the transaction amount has successfully been charged to the linked transaction accounts 136, the transaction authorization service 116 can then authorize the transaction on behalf of the merchant and cause funds to be deposited in the merchant account of the merchant. Additional information about the operation of the transaction authorization service 116 is provided later.

The transaction authorization portal 119 can be executed to generate a user interface 156 (e.g., a web page) that can be provided to the user. The user interface 156 can allow the user to submit or register linked transaction accounts 136 for use with an aggregated transaction account 129, create or modify transaction authorization rules 133, and/or view the purchasing power 153 of each of the user's linked transaction accounts 136. Additional information about the operation of the transaction authorization portal 119 is provided later.

The client device 106 is representative of a plurality of client devices that can be coupled to the network 113. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 159, such as liquid crystal displays (LCDs), gas plasma-based flat panel displays, organic light emitting diode (OLED) displays, electrophoretic ink (“E-ink”) displays, projectors, or other types of display devices. In some instances, the display 159 can be a component of the client device 106 or can be connected to the client device 106 through a wired or wireless connection.

The client device 106 can be configured to execute various applications such as a payment application 163 or other applications. The payment application 163 can include a dedicate client application for sending or receiving payments or for interacting with the transaction authorization portal 119. However, many of the functions of the payment application 163 could also be implemented as a web-browser accessing a web page provided by the transaction authorization portal 119 (e.g., as part of a web application). Whether implemented as a dedicated application or as a web-browser interacting with a web page, both implementations will be referred to herein as the payment application 163. In either implementation, the payment application 163 can cause the user interface 156 to be rendered on the display 159 of the client device 106. The client device 106 may also have a copy of the aggregated transaction account identifier 139 stored on it in some embodiments of the present disclosure. This could be done, for instance, to allow the payment application 163 to initiate a transaction with a merchant using the aggregated transaction account identifier 139.

The merchant device 109 can represent any device used by a merchant to request payment from an issuer of a transaction account. Examples of merchant devices can include point-of-sale terminals, cash registers, electronic commerce systems (e.g., online merchant “shopping carts” and/or “checkouts”), mobile computing devices (e.g., smartphones, tablets, etc.), card readers or scanners used in combination with mobile computing devices (e.g., a credit card reader provided by SQUARE® for use in credit card transactions),

The transaction authorization client 166 can include any machine-readable instructions or dedicated hardware executable by the merchant device 109 to initiate a request to authorize a transaction. Accordingly, the transaction authorization client 166 could be implemented in hardware, software, firmware, or a combination thereof. The operations of the transaction authorization client 166 are further described in later paragraphs.

Next, a general description of the operation of the various components of the network environment 100 is provided. Although the following description provides an illustrative example of the interactions between the various components of the network environment 100, this description does not describe the only implementation in which the various components of the network environment 100 may interact with each other.

To begin, a user is provided with an aggregated transaction account 129 (e.g., in response to a user registering through the transaction authorization portal 119 to be provided with an aggregated transaction account 129). The user can also provide one or more linked transaction accounts 136, which can be validated or authenticated by the transaction authorization service 116 (e.g., to prevent fraud). Once validated, the linked transaction accounts 136 can be used to provide the financing for transactions using the aggregated transaction account 129.

Next, the user may wish to make a purchase using his or her aggregated transaction account 129. For example, the use may wish to purchase an item that costs $1,000, but only have a credit card with a purchasing power 153 of $600 and a debit card with a purchasing power of $500. Accordingly, the user could provide his or her aggregated transaction account identifier 139 to a merchant or merchant device 109 (e.g., placing his or her smartphone near a merchant device 109 in order for the payment application 163 to transmit the aggregated transaction account identifier 139 to the merchant device using near field communications (NFC)). The merchant device 109 could then execute the transaction authorization client 166 to provide the aggregated transaction account identifier 139 to the transaction authorization service 116 to authorize the transaction.

In response, the transaction authorization service 116 can identify an application transaction authorization rule 133 and process the transaction accordingly. For example, the transaction authorization service 116 could determine that a transaction authorization rule 133 created by the user states that the charge should be evenly split between the credit card and debit card of the user. Accordingly, the transaction authorization service 116 could initiate a first charge of $500 with the issuer 143 of the credit card and initiate a second charge of $500 with the issuer 143 of the debit card of the user. Assuming that both charges are approved, indicating that the funds are available, the transaction authorization service 116 could then complete the transaction by depositing $1,000 in the merchant account of the merchant. The result is that even though the merchant device 109 and/or the transaction authorization client 166 may not be configured to allow for a split transaction where a portion of the purchase is paid with a first payment instrument and a remaining portion is paid with an additional payment instrument, a user can still split the transaction amount across multiple linked transaction accounts 136 through the use of his or her aggregated transaction account 129.

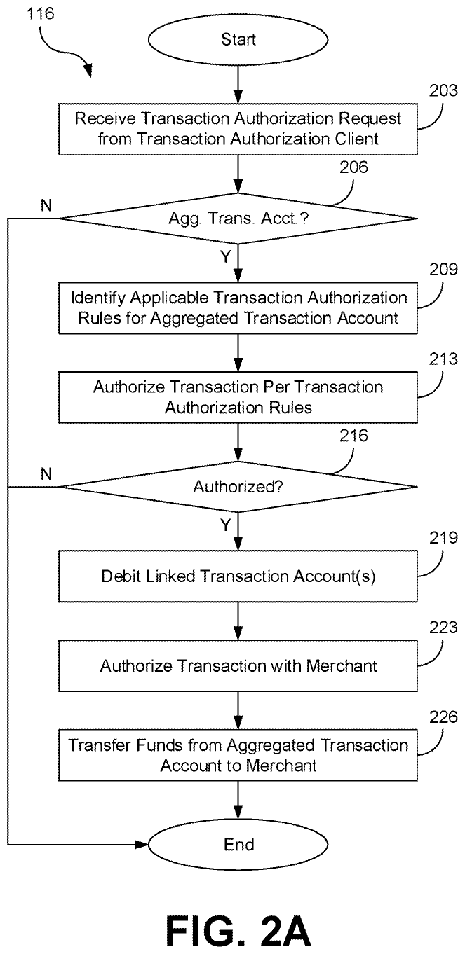

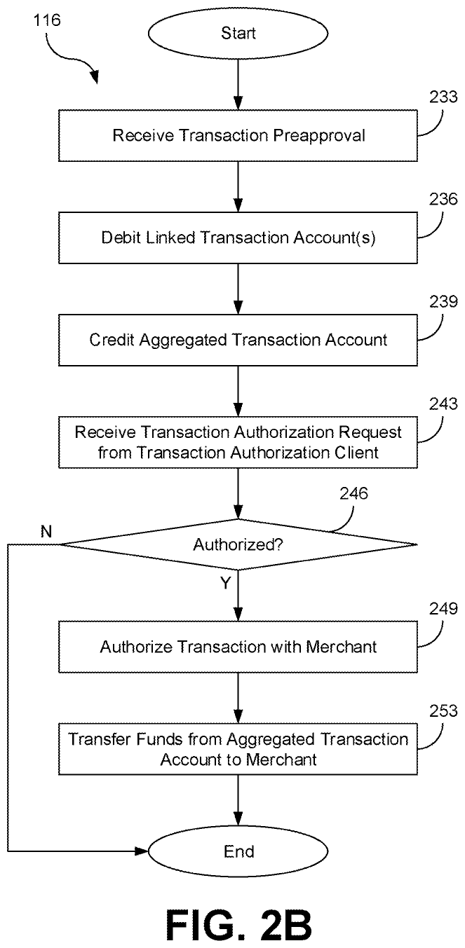

Referring next to FIG. 2A, shown is a flowchart that provides one example of the operation of a portion of the transaction authorization service 116. The flowchart of FIG. 2A provides merely an example of the many different types of functional arrangements that can be employed to implement the operation of the depicted portion of the transaction authorization service 116. As an alternative, the flowchart of FIG. 2A can be viewed as depicting an example of elements of a method implemented within the network environment 100.

Beginning with block 203, the transaction authorization service 116 can receive a transaction authorization request from a transaction authorization client 166. The request can include a transaction amount, an aggregated transaction account identifier 139, and potentially other information. This could occur, for example, when a user of the aggregated transaction account 129 attempts to make a purchase with the aggregated transaction account 129.

Next at block 206, the transaction authorization service 116 can analyze the aggregated transaction account identifier 139 to determine whether it identifies an aggregated transaction account 129. For instance, the transaction authorization service 116 could determine whether the received aggregated transaction account identifier 139 is properly formatted and/or matches an aggregated transaction account 129 associated with a user account 126. If the aggregated transaction account identifier 139 properly identifies a valid aggregated transaction account 129, then the process proceeds to block 209. Otherwise, the process ends.

Then at block 209, the transaction authorization service 116 can identify one or more transaction authorization rules 133 applicable to the transaction. For example, the transaction authorization service 116 could determine the identity of the merchant requesting authorization, the transaction amount, and other information about the transaction to identify one or more relevant transaction authorization rules 133. If multiple transaction authorization rules 133 apply, then the transaction authorization service 116 could select a transaction authorization rule 133 based on a priority or rank associated with the individual transaction authorization rules 133.

Moving on to block 213, the transaction authorization service 116 can authorize the transaction per the selected transaction authorization rule 133. For example, the transaction authorization service 116 can attempt to authorize a transaction with one or more linked transaction accounts 136 specified in the transaction authorization rule(s) 133 identified at block 209. If a transaction amount for a purchase with a merchant were to be split across multiple linked transaction accounts 136, then the transaction authorization service 116 could attempt to authorize a portion of the transaction amount with the issuer 143 of each linked transaction account 136.

Proceeding to block 216, the transaction authorization service 116 can determine whether each transaction initiated with a linked transaction account 136 was authorized. If any of the transactions initiated with the linked transaction account 136 fail to be authorized, the process can end. This can result in the transaction authorization service 116 declining the transaction with the transaction authorization client 166. However, in some implementations, the transaction authorization service 116 could first try to authorized the transaction with a different linked transaction account 136, assuming another one with sufficient purchasing power 153 is linked to the user account 126 and permitted to be used by the transaction authorization rule 133 identified at block 209. If authorization is successful, then the process proceeds to block 219.

Then at block 219, the transaction authorization service 116 can debit a portion of the transaction amount to each linked transaction account 136. For example, if a purchase had a transaction amount of $1,200, the transaction authorization service 116 could debit (or otherwise charge or collect) $800 from a first linked transaction account 136 and debit (or otherwise charge or collect) $400 from a second linked transaction account 136.

It should be noted that the operations of blocks 213 through 219 may be performed simultaneously or in parallel. For example, authorization of a transaction at block 213 may also involve debiting a linked transaction account 136 as described at block 219.

Finally, at block 223, the transaction authorization service 116 can authorize the transaction with the merchant. This can include returning an authorization success message to the merchant. It can also involve causing an amount of funds equal to the transaction amount (minus a processing fee in some embodiments) to be deposited into the merchant account of the merchant, as illustrated at block 226. Once the transaction is authorized, the process ends.

Referring next to FIG. 2B, shown is a flowchart that provides one example of the operation of a portion of the transaction authorization service 116. The flowchart of FIG. 2B provides merely an example of the many different types of functional arrangements that can be employed to implement the operation of the depicted portion of the transaction authorization service 116. As an alternative, the flowchart of FIG. 2B can be viewed as depicting an example of elements of a method implemented within the network environment 100.

Beginning at block 233, transaction authorization service 116 can receive a transaction preapproval. For example, the transaction authorization service 116 could receive instructions or commands from the payment application 163 or transaction authorization portal 119 specifying an amount of money to be added to an aggregated transaction account 129 and which linked transaction accounts 136 that funds should be transferred from. This could effectively turn the aggregated transaction account 129 into a stored-value payment instrument. In some implementations, the transaction preapproval could further specify the merchant at which the next purchase should be made.

This could occur, for example, when a user knows of a purchase that he or she plans on making in the near future. For example, if a user knows he or she wants to make a $1,000 purchase, then the user could use the payment application 163 and/or the transaction authorization portal 119 to instruct the transaction authorization service 116 to transfer funds from one or more linked transaction accounts 136 to assemble a $1,000 balance on the aggregate transaction account 129.

Then at block 236, transaction authorization service 116 causes the linked transaction accounts 136 identified at block 233 to be debited by the amounts specified at block 233. This may be performed in order to ensure that the appropriate funds are stored on the aggregated transaction account 129 prior to a purchase.

Moving on to block 239, transaction authorization service 116 can similarly credit the aggregated transaction account 129 by an amount equal to the total amount debited from the linked transaction accounts 136 at block 236.

Next at block 243, the transaction authorization service 116 can receive a transaction authorization request from a transaction authorization client 166. The request can include a transaction amount, an aggregated transaction account identifier 139, and potentially other information. This could occur, for example, when a user of the aggregated transaction account 129 attempts to make a purchase with the aggregated transaction account 129.

Proceeding to block 246, the transaction authorization service 116 can determine whether the transaction had been previously authorized at block 233. For example, if block 233 had identified the merchant with whom the purchase were to be made, then the transaction authorization service 116 could compare the merchant identifier received at block 243 with the merchant identifier specified at block 233. If the transaction is authorized, the process can proceed to block 249. If the transaction is unauthorized, then the process can end.

Then at block 249, the transaction authorization service 116 can authorize the transaction with the merchant. This can include returning an authorization success message to the merchant. It can also involve causing an amount of funds equal to the transaction amount (minus a processing fee in some embodiments) to be deposited into the merchant account of the merchant, as illustrated at block 253. Once the transaction is authorized, the process ends.

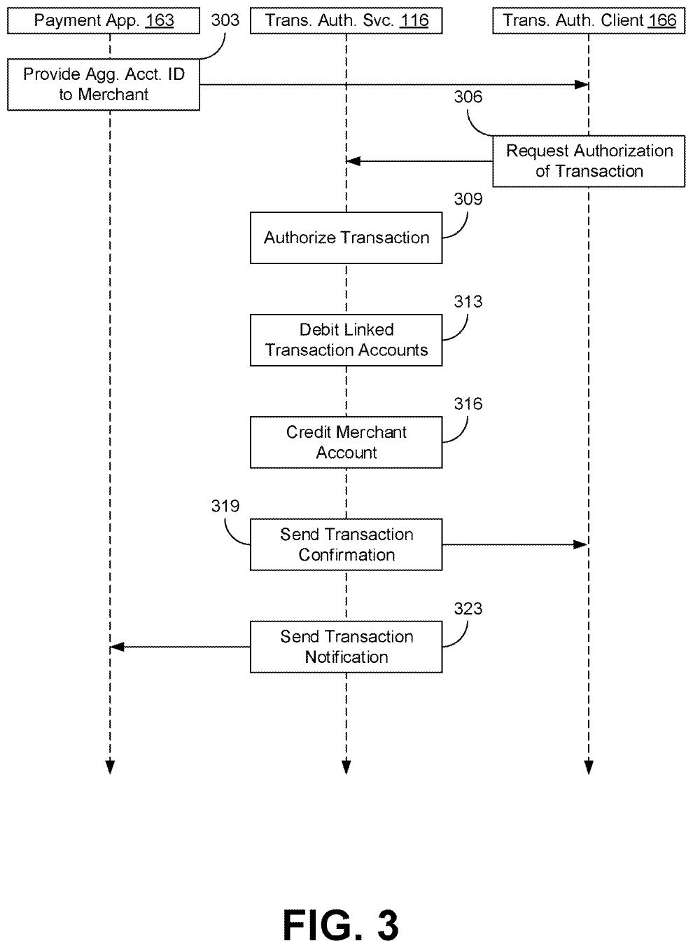

Referring next to FIG. 3, shown is a sequence diagram that provides one example of the interactions between portions of the payment application 163, transaction authorization service 116, and the transaction authorization client 166 according to various embodiments of the present disclosure. The sequence diagram of FIG. 3 provides merely an example of the many different types of functional arrangements that can be employed to implement the operation of the depicted portion of the payment application 163, transaction authorization service 116, and the transaction authorization client 166 according to various embodiments of the present disclosure. As an alternative, the sequence diagram of FIG. 3 can be viewed as depicting an example of elements of a method implemented within the network environment 100.

Beginning with block 303, the payment application 163 can provide the aggregated transaction account identifier 139 to the transaction authorization client 166 of a merchant device 109. This could occur, for example, when a user holds his or her smartphone in proximity to a point-of-sale terminal, thereby causing the smartphone to transmit the aggregated transaction account identifier 139 to the point-of-sale terminal. However, this could similarly occur if, for example, the client device 106 cause the aggregated transaction account identifier 139 to be automatically inputted into a payment form on a web page to allow a user to submit payment using the aggregated transaction account 129 to an online merchant or service provider.

Next at block 166, the transaction authorization client 166 can request authorization of the transaction from the transaction authorization service 116. The request can include a transaction amount, an aggregated transaction account identifier 139, and potentially other information.

Moving on to block 309, the transaction authorization service 116 can authorize the transaction. Assuming that the transaction is authorized, then the transaction authorization service 116 can debit the linked transaction accounts 136 of the user at step 313. Once the transaction authorization service 116 has collected funds by debiting the linked transaction accounts 136 of the user, the transaction authorization service can credit (or cause to be credited) the funds to the merchant account of the merchant at step 316. Steps 309 through 316 can be performed, in whole or in part, using the process previously described in FIG. 2.

Once funds have been credited, a transaction confirmation can be sent to the transaction authorization client 166. For example, an authorization confirmation could be sent to a point-of-sale terminal to indicate that the transaction is authorized, so that the transaction can be completed between the merchant and the user. Similarly, an authorization confirmation could be sent to an e-commerce merchant so that goods could be shipped or service performed.

Similarly, the transaction authorization service 116 could send a message to the payment application 163 that the transaction using the aggregated transaction account 129 had been authorized. This would allow the user to confirm the amount of funds spent, the identity of the merchant, and other information. A user might wish to receive such confirmations in order to confirm whether or not his or her aggregated transaction account 129 had been fraudulently used by a third party or in order to confirm that a transaction was, in fact, authorized and that the merchant received payment.

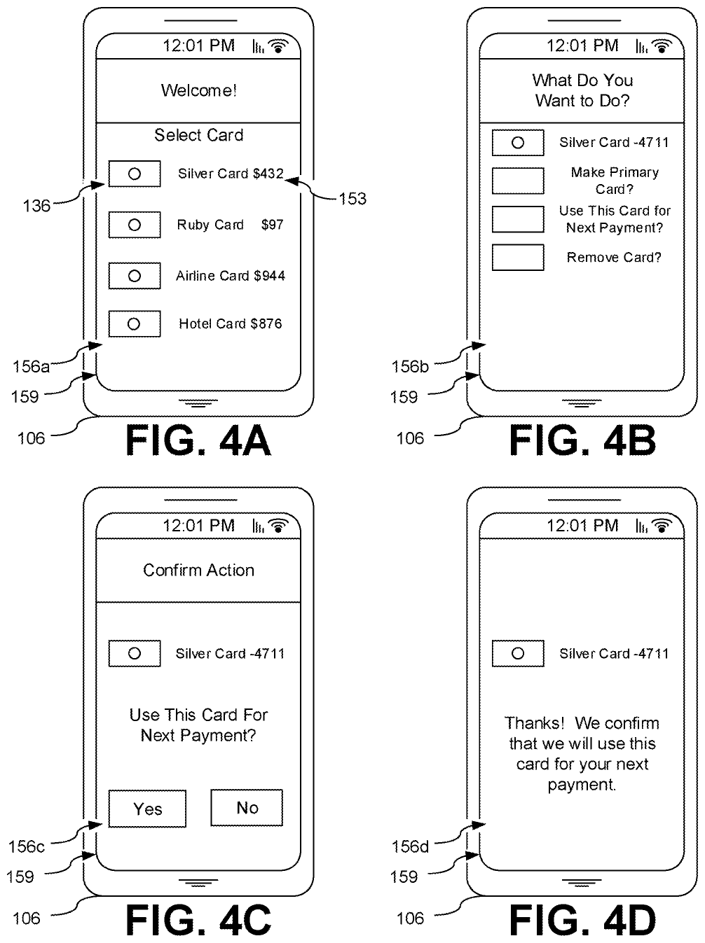

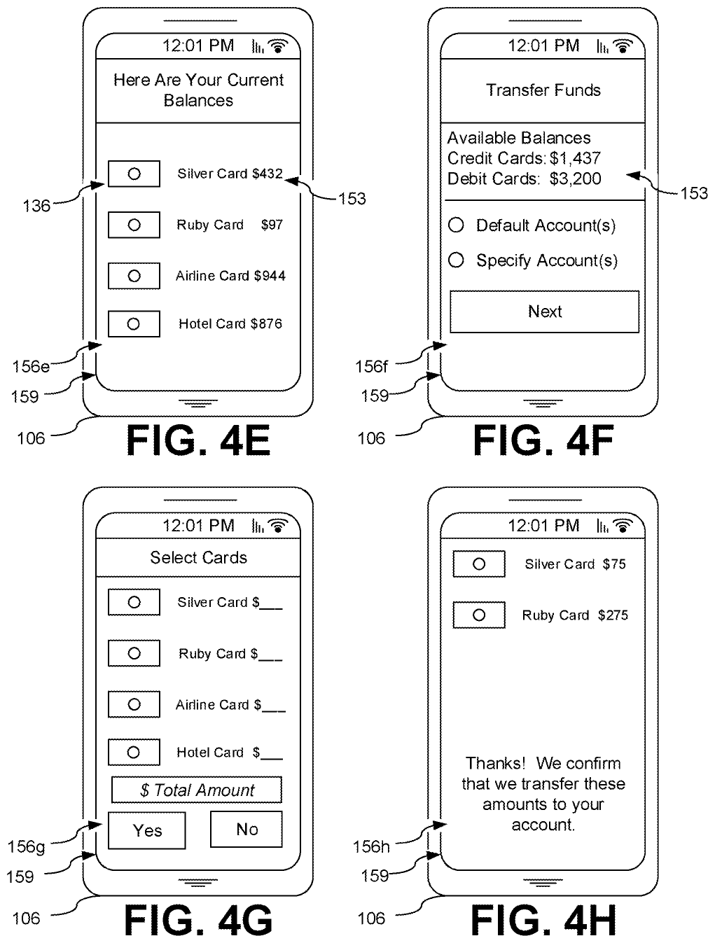

Referring next to FIG. 4A, shown is user interface diagram according to various embodiments of the present disclosure. As illustrated in FIG. 4A, a user of a client device 106 could interact with the payment application 163 to view a user interface 156a on the display 159 of the client device 106. Here, the user interface 156a could be presented to the user after he or she logs in. As shown, a user can see each linked transaction account 136 linked to his or her user account 126 and the current purchasing power 153 associated with each linked transaction account 136. Should the user wish to perform a particular action on a linked transaction account 136, or view more information about the linked transaction account 136, the user can select it within the user interface 156a.

Turning now to FIG. 4B, shown is user interface diagram according to various embodiments of the present disclosure. A user might be presented with the user interface 156b illustrated in FIG. 4B in response to selecting one of the linked transaction accounts 136 rendered on the user interface 156a of FIG. 4A. As shown, a number of options for creating various types of transaction authorization rules 133 can be presented. Although rather simple rules are illustrated on the user interface 156b of FIG. 4B, more complicated transaction authorization rules 133 or combinations of transaction authorization rules 133 could also be presented to the user as options.

In response to selecting an option to create a transaction authorization rule 133, such as using the selected linked transaction account 136 for the next payment using the aggregated transaction account 129, a user could be presented with the user interfaces 156c and 156d depicted in FIGS. 4C and 4D. These user interfaces 156c and 156d present the user with the option to confirm his or her decision.

FIG. 4E shows another user interface diagram according to various embodiments of the present disclosure. In some implementations, a user may only wish to see the outstanding purchasing power 153 for each of his or her linked transaction accounts 136. Accordingly, a user could be presented with the user interface 156e, which shows the purchasing power 153 for individual linked transaction accounts 136 without providing any options for performing a particular action.

As previously discussed, the aggregated transaction account 129 could also be operated as a stored-value payment instrument in some implementations of the present disclosure. In such implementations, a user could be presented with a user interface 156f, as depicted in the user interface diagram of FIG. 4F. As illustrated, a user could be shown their total or aggregate purchasing power 153 of various types of accounts. A user could also be presented with an option to transfer funds from one or more linked transaction accounts 136 to his or her aggregate transaction account 129. For example, a user could select to transfer funds from one or more default linked transaction accounts 136, as specified by one or more transaction authorization rules 133. As another example, a user could choose to select one or more linked transaction accounts 136 to use as a source of funds.

FIG. 4G shows an example of a user interface diagram according to various embodiments of the present disclosure. For example, in response to choosing to identify specific linked transaction accounts 136 using the user interface 156f, the user could be presented with a list of cards or linked transaction accounts 136. The use could be prompted to enter an amount of funds to be transferred from individual linked transaction accounts 136, as well as a total amount that the user wants to transfer. So long as the sum of the individual amounts specified for the individual linked transaction accounts 136 matches the total amount specified, then the user can proceed with the transfer of funds to his or her aggregate transaction account 129. A confirmation screen could then be rendered for the user, an example of which is depicted as user interface 156h of FIG. 4H.

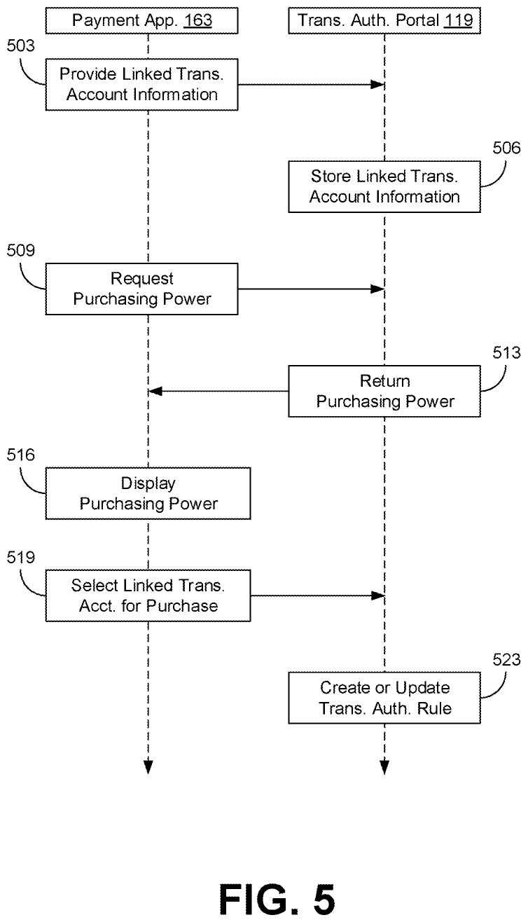

Referring next to FIG. 5, shown is sequence diagram that provides one example of the interaction between a portion of the payment application 163 and the transaction authorization portal 119. The sequence diagram of FIG. 5 provides merely an example of the many different types of functional arrangements that can be employed to implement the interaction between the depicted portion of the payment application 163 and the transaction authorization portal 119. As an alternative, the sequence diagram of FIG. 5 can be viewed as depicting an example of elements of a method implemented within the network environment 100.

Beginning with block 503, the payment application 163 can provide information for one or more linked transaction accounts 136 to the transaction authorization portal 119. For instance, the user could use the payment application 163 to submit information regarding the issuer 143, account identifier 146, authentication credentials 149, etc. of each linked transaction account 136 submitted. This could occur, for example, in response to the user using the payment application 163 to login to or otherwise authenticate with the transaction authorization portal 119.

Then at block 506, the transaction authorization portal 119 can store each linked transaction account 136 provided by the payment application 163 in the user account 126 of the user. When storing a linked transaction account 136, the transaction authorization portal 119 may calculate, or cause another service to calculate, the purchasing power 153 of the linked transaction account 136. For instance, the transaction authorization portal 119 could use the authentication credentials 149 provided to make an API call to the issuer 143 or login to the website of the issuer 143 to request or retrieve the current credit limit and outstanding balance of a credit card, and calculate the available credit in response. As another example, the transaction authorization portal 119 could use the authentication credentials 149 to make an API call to the issuer 143 or login to a website of the issuer 143 and retrieve or request the current amount of available credit or the current available balance associated with the account.

Next at block 509, the payment application 163 may make a request to retrieve or view the purchasing power 153 associated with one or more linked transaction accounts 136. For example, a user may login to the payment application 163 and request to view the purchasing power 153 of one or more linked transaction accounts 136 to decide which one to use for an upcoming purchase.

Moving on to block 513, the transaction authorization portal 119 can provide the purchasing power 153 in response. In some instances, the purchasing power 153 may be included in a web page sent in response to the payment application 163. In other instances, the purchasing power 153 may be sent by itself, which can then be rendered on an application screen of the payment application 163. Where the purchasing power 153 was requested for multiple linked transaction accounts 136, multiple purchasing powers 153 can be provided in response.

Next at block 516, the payment application 163 can display the purchasing power 153. For example, the payment application 163 could create or generate a user interface 156 rendered on a display 159 of the client device 106. The user interface 156 could show the purchasing power 153

Proceeding to block 519, the payment application 163 can provide the account identifier 146 of a linked transaction account 136 selected by the user. For example, if multiple linked transaction accounts 136 were displayed to the user at step 519, a user may have selected one of the linked transaction accounts 136 to use to make a subsequent purchase. This selection can be provided to the transaction authorization portal 119. In some cases, multiple linked transaction accounts 136 can be selected (e.g., if a purchase is to be made using the purchasing power 153 of several linked transaction accounts 136).

Then at block 523, the transaction authorization portal 119 can create or update a transaction authorization rule 133 based on the selection. For example, the transaction authorization portal 119 could create a transaction authorization rule 133 that the linked transaction account(s) 136 selected at step 519 should be used for the next purchase. If multiple linked transaction accounts 136 were selected, then the transaction authorization portal 119 could also specify in the transaction authorization rule 133 how the transaction amount of the purchase should be split across the selected linked transaction accounts 136.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a transaction authorization request for a transaction from a merchant device, the transaction authorization request comprising an aggregated transaction account identifier, a transaction amount, and a merchant identifier;
identify an aggregated transaction account by the aggregated transaction account identifier, wherein the aggregated transaction account has a first linked transaction account and a second linked transaction account;
identify a first transaction authorization rule, wherein the first transaction authorization rule directs a transaction authorization service to process the transaction authorization request using the first linked transaction account;
identify a second transaction authorization rule, wherein the second transaction authorization rule directs the transaction authorization service, when the transaction authorization service rejects the transaction authorization request for the first linked transaction account, to process the transaction authorization request using the second linked transaction account;
direct the transaction authorization service to process the transaction authorization request based on the first transaction authorization rule;
direct the transaction authorization service to process the transaction authorization request based on the second transaction authorization rule; and
send a transaction authorization response to the merchant device.

2. The system of claim 1, wherein the aggregated transaction account has a third linked transaction account and wherein the machine-readable instructions, when executed by the processor, further cause the computing device to at least:
identify a third transaction authorization rule, wherein the third transaction authorization rule directs the transaction authorization service, when the transaction authorization service rejects the transaction authorization request for the second linked transaction account, to process the transaction authorization request using the third linked transaction account; and
direct the transaction authorization service to process the transaction authorization request based on the third transaction authorization rule after the transaction authorization service rejects the transaction authorization request for the second linked transaction account.

3. The system of claim 1, wherein the transaction authorization request is a first transaction authorization request and wherein the transaction authorization service processes the transaction authorization request based on a transaction authorization rule by:
sending a second transaction authorization request, wherein the second transaction authorization request comprises an account identifier for the first linked transaction account and the transaction amount; and
receive a second transaction authorization response.

4. The system of claim 3, wherein the transaction authorization service rejects the first transaction authorization request after receiving the second transaction authorization response, the second transaction authorization response containing data which indicates authorization failure.

5. The system of claim 1, wherein the transaction authorization service processes the transaction authorization request based on the first transaction authorization rule by:
attempting to debit the transaction amount from the first linked transaction account; and
rejecting the transaction authorization request based on the first transaction authorization rule because the transaction authorization service failed to debit the transaction amount from the first linked transaction account.

6. The system of claim 1, wherein the transaction authorization service processes the transaction authorization request based on the second transaction authorization rule by:
attempting to debit the transaction amount from the second linked transaction account; and
accepting the transaction authorization request based on the first transaction authorization rule because the transaction authorization service succeeded to debit the transaction amount from the second linked transaction account failed.

7. The system of claim 1, wherein the merchant device is a point-of-sale terminal, cash register, electronic commerce, mobile computing devices, card reader, or a scanner used in combination with a mobile computing device.

8. A method for a transaction authorization service comprising:
receiving a transaction authorization request for a transaction from a merchant device, the transaction authorization request comprising an aggregated transaction account identifier, a transaction amount, and a merchant identifier;
identifying an aggregated transaction account by the aggregated transaction account identifier, wherein the aggregated transaction account has a first linked transaction account and a second linked transaction account;
identifying a transaction authorization rule for the aggregated transaction account that directs the transaction authorization service, after the transaction authorization service fails to authorize the transaction authorization request using the first linked transaction account, to authorize the transaction authorization request using the second linked transaction account;
sending a first issuer authorization request to the issuer of the first linked transaction account, the first issuer authorization request comprising the transaction amount and the merchant identifier;
receiving a first issuer authorization response from the issuer of the first linked transaction account rejecting the first issuer authorization request;
sending a second issuer authorization request to the issuer of the second linked transaction account, the second issuer authorization request comprising the transaction amount and the merchant identifier;
receiving a second issuer authorization response from the issuer of the second linked transaction account; and
sending an authorization response to the merchant device, the authorization response indicating that the transaction is authorized for the transaction amount.

9. The method of claim 8, wherein the first linked transaction account is a credit card and the receiving a first issuer authorization response from the issuer of the first linked transaction account rejects the first issuer authorization request due to lack of sufficient credit related to the credit card.

10. The method of claim 8, wherein the first linked transaction account is a debit card and the receiving a first issuer authorization response from the issuer of the first linked transaction account rejects the first issuer authorization request due to lack of sufficient funds related to the debit card.

11. The method of claim 8, wherein the second linked transaction account is a credit card, a charge card, a debit card, or a stored value payment instrument.

12. The method of claim 8, wherein the transaction authorization account further comprises a third linked transaction account, the transaction authorization rule further directs the transaction authorization service to authorize the transaction authorization request using the third linked transaction account after the transaction authorization service fails to authorize the transaction authorization request using the second linked transaction account.

13. The method of claim 12 comprising additional steps after receiving a second issuer authorization response from the issuer of the second linked transaction account, but before sending an authorization response to the merchant device, the authorization response indicating that the transaction is authorized for the transaction amount:
sending a third issuer authorization request to the issuer of the third linked transaction account, the third issuer authorization request comprising the transaction amount and the merchant identifier; and
receiving a third issuer authorization response from the issuer of the third linked transaction account accepting the third issuer authorization request.

14. A system, comprising:
a computing device comprising a processor and a memory; and
machine-readable instructions stored in the memory that, when executed by the processor, cause the computing device to at least:
receive a transaction authorization request for a transaction from a merchant device, the transaction authorization request comprising an aggregated transaction account identifier, a transaction amount, and a merchant account identifier for a merchant account;
identify an aggregated transaction account by the aggregated transaction account identifier, wherein the aggregated transaction account at least has:
a first linked transaction account having a first account identifier and a first purchasing power; and
a second linked transaction account having a second account identifier and second purchasing power;
identify a first transaction authorization rule for the aggregated transaction account, wherein the first transaction authorization rule causes the system, if the transaction amount does not exceed the first purchasing power, to initiate a first payment from the first linked transaction account to the merchant account;
identify a second transaction authorization rule for the aggregated transaction account, wherein the second transaction authorization rule causes the system, when the system fails to complete the first payment, to initiate a second payment from the second transaction account to the merchant account;
compare the first purchase power to the transaction amount;
initiate a first payment from the first linked transaction to the merchant account;
initiate a second payment from the second linked transaction to the merchant account; and
send an authorization response to the merchant device.

15. The system of claim 14, wherein the second transaction authorization rule causes the system to initiate the second payment when the system fails to complete the first payment and when the transaction amount exceeds the second purchasing power, and wherein the machine-readable instructions, when executed by the processor, further cause the computing device to at least compare the second purchase power to the transaction amount.

16. The system of claim 14, wherein the authorization response comprises data indicating authorization success if the first payment or the second payment completed successfully.

17. The system of claim 14, wherein the first linked transaction account is a credit card, a charge card, a debit card, or a stored value payment instrument.

18. The system of claim 14, wherein the aggregated transaction account has a third linked transaction account and wherein the machine-readable instructions, when executed by the processor, further cause the computing device to at least:
identify a third transaction authorization rule for the aggregated transaction account, wherein the third transaction authorization rule causes the system, when the system fails to complete the second payment, to initiate a third payment from the third transaction account to the merchant account; and
initiate a third payment from the third linked transaction to the merchant account.

19. The system of claim 18, wherein the third linked transaction account has a third purchasing power, wherein the third transaction authorization rule causes the system to initiate the third payment when the system fails to complete the second payment and when the transaction amount exceeds the second purchasing power, and wherein the machine-readable instructions, when executed by the processor, further cause the computing device to at least compare the third purchase power to the transaction amount.

20. The system of claim 18, wherein the authorization response comprises data indicating authorization success if the first payment, the second payment, or the third payment completed successfully.
